(19) United States
(12) Patent Application Publication
(10) Pub. No.: US 2026/0368922 A1
(43) Pub. Date: Nov. 19, 2026

(54) SYSTEM AND METHOD FOR OBJECT DETECTION

(71) Applicant: Caterpillar Inc., Peoria, IL (US)

(72) Inventors: Lawrence A. Mianzo, Pittsburgh, PA (US); Michael Hoffelder, Norwich, NY (US); Tod A. Oblak, Pittsburgh, PA (US); Jeremy Borgman, Dunlap, IL (US); Yuan Shi, Cranberry Township, PA (US)

(73) Assignee: Caterpillar Inc., Peoria, IL (US)

(21) Appl. No.: 19/212,426

(22) Filed: May 19, 2025

(51) Int. Cl. G06T 7/73; G05D 1/243; G05D 1/622; G05D 105/05; G05D 111/10; G06T 7/11; G06T 7/55

(52) U.S. Cl. CPC G06T 7/74; G05D 1/2435; G05D 1/622; G06T 7/11; G06T 7/55; G05D 2105/05; G05D 2111/10; G06T 2207/20081; G06T 2207/20084

(57) ABSTRACT

A controller device of a work machine may receive first image data from a first camera and a second camera affixed to the work machine. The controller device determines a first segmentation mask for an object represented in the first image data, the first segmentation mask comprising a first hierarchical instance segmentation of the object and a second segmentation mask for the object represented in the second image data, the second segmentation mask comprising a second hierarchical instance segmentation of the object. The controller device then determines a correspondence between the first segmentation mask and the second segmentation mask. The controller device determines a distance from the work machine to the object based on the correspondence and controls an operation of the work machine based at least in part on the distance.

### TECHNICAL FIELD

The present disclosure generally relates to a system and method for detecting objects, and more particularly, to a system and method for using two or more cameras for determining the depth position of an obstacle in an environment using hierarchical instance segmentation.

### BACKGROUND

Machines, such as excavators, may be used to perform a variety of tasks at a worksite. For example, excavators may be used to excavate, move, shape, contour, and/or remove material at the worksite, such as gravel, concrete, asphalt, soil, and/or other materials.

Some excavators include systems that identify objects of interest, such as personnel or obstacles, and provide alerts to the operator indicating the presence of such objects. To achieve broad coverage around the vehicle, multiple cameras with wide fields of view are typically used. Such cameras are typically characterized as having relatively high image distortion due to their wide fields of view. Further, these cameras are often not synchronized during image capture. Due to Bayer artifacts, compression artifacts, low data rate, and non-robust and rigid extrinsic relationships of the cameras, it is difficult to get accurate ranging and depth estimation from the image data.

In order to estimate range of objects in the scene, one approach is to use a flat ground assumption. However, due to large image distortion, variations in scale of objects and associated errors in bounding boxes, as well as non-flat ground in work environments such as construction zones, it is difficult to obtain accurate estimation with this approach. Another approach is to use monocular depth estimation deep learning or bird's eye view based deep learning networks. However, with monocular depth estimation, while 3D structure can be recovered, scale cannot be recovered but can be only estimated. Additionally, monocular depth estimation and/or bird's eye deep learning networks require large amounts of labeled ground truth data which is expensive and time consuming to obtain.

An example system and method for performing object detection is described in U.S. patent application No. 20220261593 to Yu et al., filed Feb. 16, 2021, titled “Using Neural Networks to Perform Object Detection, Instance Segmentation, and Semantic Correspondence from Bounding Box Supervision” (hereafter “the '593 document”). In particular, the '593 document describes techniques to train one or more neural networks to perform segmentation tasks for object detection.

Although the '593 document describes such a system and method for object detection using various techniques, the system and method described do not perform depth determination for the object and/or for portions of the objects as detected. Accordingly, the systems and methods described in the '593 document do not provide for depth estimation of different objects in a work environment, and in particular, do not account for distances or depths to different portions of objects as is needed for collision avoidance and other such systems of a work machine in a work environment.

Examples of the present disclosure are directed to overcoming the deficiencies described above.

### SUMMARY OF THE INVENTION

Systems and methods are provided for determination of distances and depths to objects in an environment surrounding a work machine. In some aspects, the techniques described herein relate to a method, including receiving first image data from a first camera affixed to a work machine, receiving second image data from a second camera affixed to the work machine, determining a first segmentation mask for an object represented in the first image data, the first segmentation mask including a first hierarchical instance segmentation of the object, and determining a second segmentation mask for the object represented in the second image data, the second segmentation mask including a second hierarchical instance segmentation of the object. Such methods also include determining a correspondence between the first segmentation mask and the second segmentation mask, determining a distance from the work machine to the object based on the correspondence, and controlling an operation of the work machine based at least in part on the distance.

In some aspects, the techniques described herein relate to a system, including a work machine, a first camera, a second camera, and an electronic control module configured to perform operations including receiving first image data from the first camera, receiving second image data from the second camera, and determining a first segmentation mask for an object represented in the first image data, the first segmentation mask including a first hierarchical instance segmentation of the object. Such operations also include determining a second segmentation mask for the object represented in the second image data, the second segmentation mask including a second hierarchical instance segmentation of the object, determining a correspondence between the first segmentation mask and the second segmentation mask, and determining a distance from the work machine to the object based on the correspondence. Such methods further include and controlling an operation of the work machine based at least in part on the distance.

In some aspects, the techniques described herein relate to a non-transitory computer-readable medium having instructions stored thereon that, when executed by a processor, causes the processor to perform operations including receiving first image data from a first camera affixed to a work machine, receiving second image data from a second camera affixed to the work machine, determining a first segmentation mask for an object represented in the first image data, the first segmentation mask including a first hierarchical instance segmentation of the object, and determining a second segmentation mask for the object represented in the second image data, the second segmentation mask including a second hierarchical instance segmentation of the object. Such operations also include determining a correspondence between the first segmentation mask and the second segmentation mask, determining a distance from the work machine to the object based on the correspondence, and controlling an operation of the work machine based at least in part on the distance.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an environment, such as a worksite, including a machine equipped with an object detection system, according to at least one example.

FIG. 2 illustrates a system architecture for a machine with multiple cameras for determining depth and range of objects in an environment using hierarchical instance segmentation, according to at least one example.

FIG. 3 illustrates an example system for implementation on a machine including six example cameras communicably coupled with an ECM of the machine, according to at least one example.

FIG. 4 illustrates a method for performing hierarchical instance segmentation to determine depth and range of objects from a machine, according to at least one example.

FIG. 5 illustrates a method for performing hierarchical instance segmentation to determine depth and range of objects from a machine, according to at least one example.

FIG. 6 illustrates a computer architecture diagram showing illustrative hardware architecture for implementing aspects of various technologies of the present disclosure.

### DETAILED DESCRIPTION

Wherever possible, the same reference numbers will be used throughout the figures to refer to the same or like parts. In the figures, the left-most digit(s) of a reference number identifies the figure in which the reference number first appears.

The present description is generally directed to systems and methods for detecting objects in an environment, such as a worksite, using sensors such as monocular vision cameras. In some examples, a machine may define a working area within the environment. In some examples of the systems and methods, one of the sensors may detect an object in the environment and may determine whether the object is within the working area. Objects that are within the working area may cause alerts to be issued and/or movement of the machine, or a work implement connected to the machine, to be controlled. Some examples of the systems and methods described herein are related to the use of cameras, along with other sensors, to perform hierarchical image segmentation and depth detection. That is, the object(s) may be detected and the distance to the segments or portions of the objects may be readily identified based on image data from synchronized cameras. Accordingly, the systems and methods herein may provide for object detection and depth estimation for objects and portions of objects within the working area.

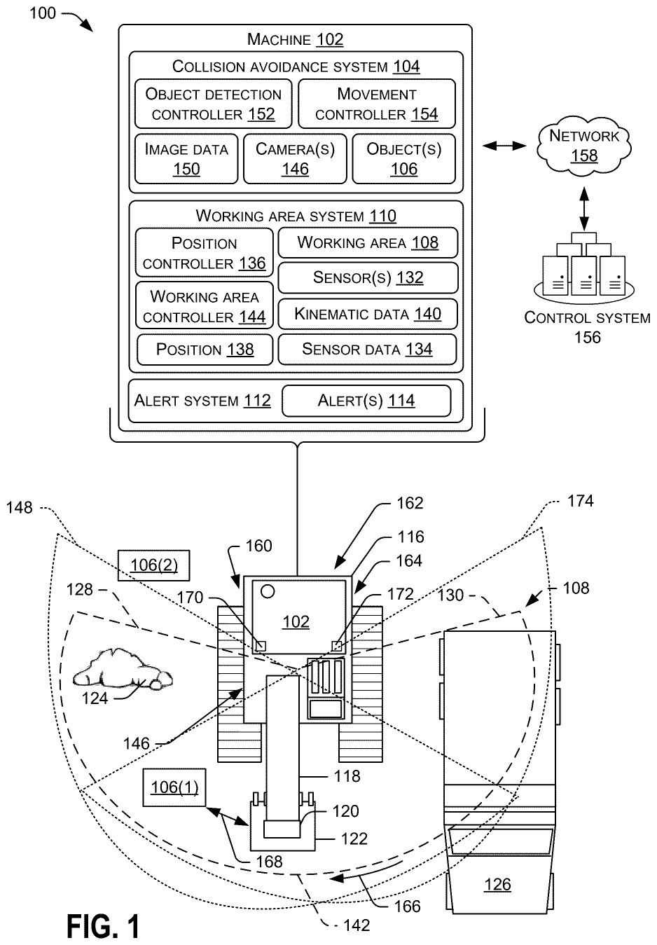

FIG. 1 is a schematic top view of an example environment 100, such as a worksite, including an example machine 102. As described herein in detail, the machine 102 includes a collision avoidance system 104 for detecting the presence or absence of objects 106 in the environment 100, and specifically, within a working area 108. As will be described in greater detail below, the working area 108 may be defined by an operator of the machine 102 and established using a working area system 110. As the operator maneuvers the machine 102, if the objects 106 are detected within the working area 108, an alert system 112 outputs alerts 114.

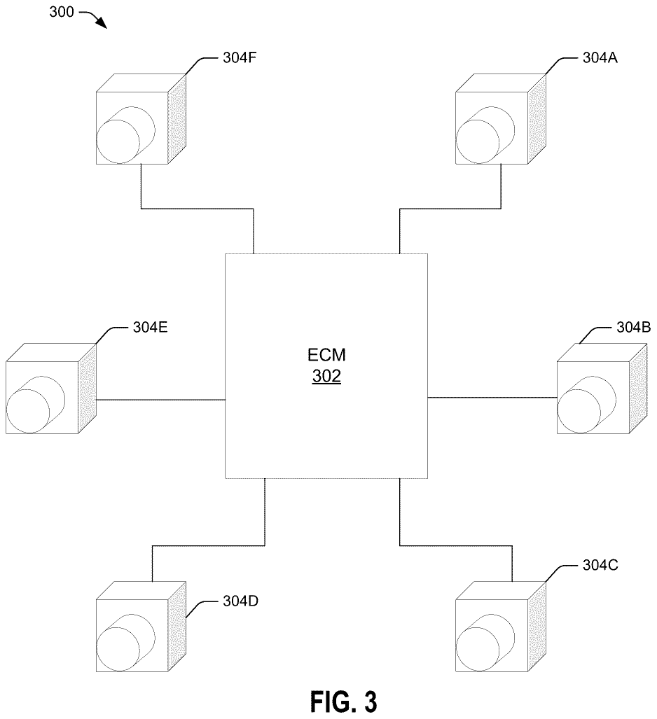

The present description, and the environment 100 relates to a wide field of view range and depth estimation using multiple wide-angle cameras for an object detection system of the machine 102. The present description provides for a low-cost and robust stereo depth estimation to achieve accurate range estimation using multiple wide-angle cameras. The image data from the cameras 170 and 172 of the machine 102 are processed using a hierarchical instance segmentation technique that is used to provide depth estimation of the distances to the objects 106 in the environment. Though shown and described with respect to FIG. 1 as including two cameras, more than two cameras may be used to provide a field of view about the machine 102 in the environment, for example as shown and described with respect to FIG. 3 herein.

Hierarchical instance segmentation is implemented according to the systems and methods described herein, as opposed to conventional object detection-based bounding boxes. Image segmentation provides segmentation masks and detections of the assets such as people, vehicles, infrastructure. The image segmentation allows accurate and robust stereo matching of the objects from the image data of the cameras 170 and 172. Hierarchical instance segmentation allows for robust detection of the objects because hierarchy imposes a constraint to enforce more accurate and higher confidence matching as part of the object detection pipeline. The hierarchical instance segmentation allows for determination of depth of large objects by decomposing the object into structured parts of segments and features that can be determined individually at varying depths. Hierarchical instance segmentation also allows for accurate fusion with 3D sensors such as radar or lidar based point clouds. Accordingly, the object detection and collision avoidance systems of a machine 102 may be improved based on improved detection of systems without addition of complex or expensive sensors and systems.

In the example of FIG. 1, the machine 102 is illustrated as an excavator. However, the machine 102 may be any type of machine configured to travel across terrain, such as an automobile, a truck, an agricultural vehicle, and/or work vehicles, such as a wheel loader, a track loader, a skid-steer loader, a mining shovel, a grader, an on-highway truck, an off-highway truck, and/or any other machine known to a person skilled in the art.

The machine 102 includes a chassis or frame 116 to which is coupled a power source (e.g., engine) configured to supply power for operation of the machine 102, including, for example, operating work implements, electronics, and steering, and/or for supplying torque to drive members to propel the machine 102 across the terrain. For example, the machine 102 shown in FIG. 1 includes a pair of tracks that are configured to propel the machine 102 across pavement, gravel, dirt, or other work surfaces of the environment 100. Although the machine 102 includes tracks, it is contemplated that the machine 102 may include one or more wheels instead of, or in addition to, the tracks. The machine 102 also includes a cab coupled to the frame 116 for protecting and/or providing comfort for an operator of the machine 102, and/or for protecting control-related devices of the machine 102. In some examples, the machine 102 may be semi-autonomous or fully autonomous, and able to operate without an onboard or remote operator.

In the example shown in FIG. 1, the machine 102 has a boom 118 with a proximal end coupled to the frame 116 and configured to pivot relative to the frame 116. The machine 102 also includes a stick 120 coupled to a distal end of boom 118 and configured to pivot relative to the boom 118. The machine 102 further includes a boom actuator coupled at one end to the frame 116 and at an opposite end to the boom 118. The boom actuator is configured to extend and retract, thereby raising and lowering the distal end of the boom 118, respectively.

The machine 102 also includes a work implement 122 for performing operations associated with the machine 102, such as digging, carrying, raising, and/or depositing material. The machine 102 includes a work implement actuator coupled at one end to the frame 116 and/or to the proximal end of the boom 118. The work implement actuator is configured to extend and retract, thereby pivoting the work implement 122 between an upright orientation and an at least partially inverted orientation, for example. In the upright orientation, the work implement 122 may hold material and in the at least partially inverted orientation, the work implement 122 may deposit or dump the material. Other forms of work implements are contemplated. For example, although the work implement 122 in FIG. 1 is illustrated as a bucket, the work implement 122 may include augers, brushcutters, brooms, grapples, hammers, pulverizers, rippers, rotors, and so forth.

As shown in FIG. 1, and as introduced above, the machine 102 includes the collision avoidance system 104, the working area system 110, and/or the alert system 112. Although FIG. 1 schematically depicts the collision avoidance system 104, the working area system 110, and the alert system 112 being separate, in some examples, the collision avoidance system 104, the working area system 110, and/or the alert system 112 may be embodied within a single system.

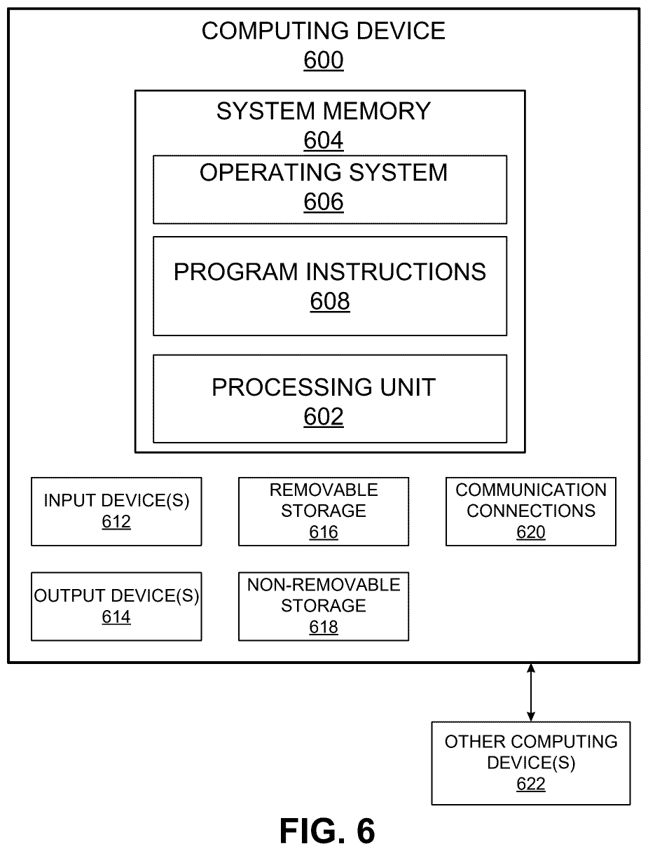

One or more of the collision avoidance system 104, the working area system 110, and/or the alert system 112 may include one or more processors, which may execute any modules associated with the collision avoidance system 104, the working area system 110, and/or the alert system 112, as explained in further detail herein. In some examples, the processor(s) may include a central processing unit (CPU), a graphics processing unit (GPU), both CPU and GPU, or other processing units or components known in the art. Additionally, each of the processors may possess its own local memory, which also may store program modules, program data, and/or one or more operating systems. One or more of the collision avoidance system 104, working area system 110, and/or the alert system 112 may include a computing device such as shown and described with respect to FIG. 6 herein.

Computer-readable media associated with the collision avoidance system 104, the working area system 110, and/or the alert system 112 may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with the collision avoidance system 104, the working area system 110, and/or the alert system 112. In some examples, one or more of the modules may include or be associated with computer-executable instructions that are stored by the computer-readable media and that are executable by one or more processors to perform such operations. The collision avoidance system 104, the working area system 110, and/or the alert system 112 may also include additional components not listed above that may perform any function associated with the collision avoidance system 104, the working area system 110, and/or the alert system 112, respectively. The collision avoidance system 104, the working area system 110, and/or the alert system 112 may communicate with one another using any known wired and/or wireless communication protocols and/or networks.

In an example, the collision avoidance system 104, the working area system 110, and/or the alert system 112 may be configured to receive information from one or more sensors of the machine 102 such as sensor(s) 132 and/or camera(s) 146 and to use the sensor data 134 to monitor the working area, provide collision avoidance, and/or alert an operator of the machine 102. For example, the working area system 110 may be configured to establish a working area 108 around the machine 102. The working area 108 may correspond to a virtual boundary, electronic fence, or geographical-based fence around the machine 102, and represent a virtual space within which the machine 102 is configured to operate. For example, the machine 102, the frame 116, the boom 118, the stick 120, and/or the work implement 122 may operate within the working area 108. Once the working area 108 is established, the operator may be prohibited from operating the machine 102 outside of the working area 108. For example, the operator may be prohibited from operating portions (e.g., ends, sides, etc.) of the machine 102, the frame 116, the boom 118, the stick 120, and/or the work implement 122 outside of the working area 108.

As shown in FIG. 1, the machine 102 may be configured to perform a variety of different tasks at a worksite or other environment, and such tasks include loading debris 124 to a transport vehicle 126. However, the machine 102 may be moving the debris 124, or other equipment, material, refuse, etc. from one location to another in the environment 100 and/or within the working area 108. The debris 124 is shown being on a right side of the machine 102 and the transport vehicle 126 is shown being on a left side of the machine 102, however, in other examples it is understood that the debris 124 and/or the transport vehicle 126 may be disposed at other locations relative to each other and/or relative to the machine 102. The operator of the machine 102 may load the debris 124 into the work implement 122 and then swing the work implement 122 leftward to deposit the debris 124 into the transport vehicle 126. Once the debris 124 has been dumped and/or otherwise removed from the work implement 122, the operator of the machine 102 may move the work implement 122 rightward to load more of the debris 124 into the work implement 122. Between the positions at which the debris 124 is loaded into the work implement 122 and unloaded into the transport vehicle 126, the operator may horizontally and vertically move the work implement 122 or otherwise operate the machine 102.

In some examples, the working area 108 may be defined at least in part by a first boundary 128, a second boundary 130, and a peripheral boundary 142 that extends from the first boundary 128 to the second boundary 130. In some examples, the working area 108 may be established, set, or determined prior to the operator beginning work within the environment 100. For example, the operator may define the working area 108 by moving the work implement 122 to a first position associated with the first boundary 128 and then to a second position associated with the second boundary 130. That is, in the example of FIG. 1, the operator may move the work implement 122 to a position corresponding to the first boundary 128 and then horizontally move the work implement 122 to a position corresponding to the second boundary 130. While the work implement 122 is positioned at the first boundary 128 (or other position in which the operator wishes to establish a boundary) the operator may provide an indication of the first boundary 128. For example, the operator may interact with a display of the machine 102, press a button on a joystick of the machine 102, and so forth. Similarly, while the work implement 122 is positioned at the second boundary 130 the operator may provide an indication of the second boundary 130.

The machine 102 includes various sensor(s) 132 for determining relative positions of the work implement 122 and other portions of the machine 102 (e.g., the boom 118, the stick 120, etc.). These sensor(s) 132 may be disposed on various portions of the machine 102. For example, one or more inertial measurement units (IMUs) may be disposed on the boom 118 and the stick 120, a positional sensor may be disposed at a joint between the stick 120 and the work implement 122, and/or a rotational sensor may be disposed at the base of the boom 118 proximate to the machine 102.

The sensor(s) 132 generate sensor data 134 that indicate relative extensions, locations, positions, rotations, etc. of the machine 102, the boom 118, the stick 120, the work implement 122, and/or portions of the machine 102. While the operator is establishing the working area 108, the sensor data 134 may be used to indicate relative positions of the machine 102, the boom 118, the stick 120, the work implement 122, and/or portions of the machine 102. For example, while at the first boundary 128, the operator may provide an indication (e.g., button press) that the first boundary 128 is associated with the working area 108 (e.g., the operator wishes to establish the first boundary 128 as a boundary of the working area 108). At this time, the sensor(s) 132 may generate sensor data 134 for purposes of knowing the locations of the machine 102, the boom 118, the stick 120, the work implement 122, and/or portions of the machine 102. Similarly, when the operator wishes to establish other boundaries, such as the second boundary 130, the sensor(s) 132 may generate the sensor data 134 for knowing the locations of the machine 102, the boom 118, the stick 120, the work implement 122, and/or portions of the machine 102 at the second boundary 130.

A position controller 136 of the machine 102 may be in communication with the sensor(s) 132 via a wired and/or a wireless communication link. The position controller 136 may be configured to process the sensor data 134 to determine positions 138 of the machine 102, the boom 118, the stick 120, the work implement 122, and/or portions of the machine 102. As the position controller 136 determines these positions 138, the position controller 136 may relay this information to the working area system 110 for purposes of establishing the working area 108. For example, a working area controller 144 may associate the positions 138 of the first boundary 128 and the second boundary 130 with the working area 108. Additionally, as discussed herein, the position controller 136 may also be used for determining whether the work implement 122, or more generally the machine 102, is operating within the working area 108.

Additionally or alternatively, kinematic data 140 may be used for establishing the working area 108. The kinematic data 140 may indicate dimensions, volumes, and/or other configurations of the boom 118, the stick 120, the work implement 122, or other components of the machine 102, such as linkages, arms, etc. coupling the boom 118 and the stick 120, for example. The kinematic data 140 may indicate movement characteristics of the boom 118, the stick 120, the work implement 122, maximum extensions or ranges of the boom 118, the stick 120, the work implement 122, and so forth. The kinematic data 140 may also indicate the connections or couplings between the stick 120 and the work implement 122, for example. The kinematic data 140 may be used in conjunction with the sensor data 134 for determining the position 138 of the work implement 122 and/or portions of the machine 102. In such instances, the position 138 controller 136 may determine, based at least in part on the sensor data 134 and/or the kinematic data 140, the location of the work implement 122 within the working area 108. The position controller 136 may also be configured to determine a position, location, and/or bearing of the work implement 122 relative to the machine 102 (or portions thereof).

The working area 108 may, in some examples, be mapped or recorded in two-dimensional (2D) or three-dimensional (3D) space around the machine 102 by the working area controller 144. For example, the working area controller 144 may generate the working area 108 in a local coordinate system around the machine 102. However, in some examples, the working area controller 1144 may generate the working area 108 in global position system (GPS) coordinates. As the machine 102 operates within the working area 108, the position controller 136 may continuously determine the position 138 of the machine 102, the boom 118, the stick 120, and/or the work implement 122. The positions 138 may be compared or transcribed within the working area 108 to determine the relative location of the machine 102, the boom 118, the stick 120, and/or the work implement 122 within the working area 108.

Although FIG. 1 illustrates a particular working area 108, in some examples, the operator may also move the work implement 122 about the environment 100 and indicate other positions corresponding to peripheries of the working area 108. In such instances, the working area 108 may be defined by the operator and based on specifics of the environment 100.

In some examples, if the operator moves the machine 102 to another environment, or location in the environment 100, the operator may reset or reestablish the working area 108. In some examples, the operator may be prompted to establish the working area 108 upon powering up of the machine 102 or the machine 102 detecting physical movement from one location to another.

Additionally, the working area 108 may be defined using additional boundaries. For example, the operator may raise and lower the work implement 122 (i.e., vertically) to establish an upper boundary and a lower boundary relative to the machine 102. This may allow the operator to establish the working area 108 to avoid trees, overpasses, gantries, manholes, sewer/communication lines, etc. In some examples, the working area 108 may also be defined at least in part by the specifics of the machine 102. For example, the machine 102 and/or the work implement 122 may have limited range of motion (e.g., rotation), a limited range of extension (e.g., horizontal reach), and/or a limited range of lift (e.g., vertical reach). Such information may be stored in the kinematic data 140. In such examples, the working area controller 144 may accept these additional boundaries for generating the working area 108.

Moreover, the machine 102, the boom 118, the stick 120, the work implement 122, and/or other portions of the machine 102 may have sensors that recognize obstacles (e.g., walls, barriers, trees, buildings, vehicles, etc.). These obstacles may be suggested as boundaries for the working area 108 and the operator may choose to accept the suggestions as boundaries, edges, or peripherals of the working area 108.

As introduced above, once the working area 108 is defined, the operator may be prevented from rotating, lifting, or extending the work implement 122 outside of the working area 108. Moreover, the frame 116, the boom 118, and/or the stick 120 may be prevented from extending outside the working area 108. As discussed above, the working area 108 may be defined for alerting the operator and/or controlling the machine 102.

The collision avoidance system 104 may be configured to prevent collisions between the machine 102 and the object(s) 106 in the environment 100. To detect the object(s) 106, the collision avoidance system 104 may include one or more camera(s) 146 mounted onto a body (e.g., the frame 116) of the machine 102. In some instances, the machine 102 may include any number of camera(s) 146, such as one, two, or three cameras. In the example shown in FIG. 1, cameras 170 and 172 are shown with camera 170 disposed on a right-side 160 of the machine 102 and camera 172 may be disposed on a left-side 164 of the machine 102. In a three-camera embodiment, a third camera may be disposed on a rear-side 162 of the machine 102. Additional cameras may be positioned about and/or on the machine 102 for providing visibility of the environment 100 and to generate image data using the cameras 170 and 172 that the collision avoidance system 104 and/or the working area system 110 may use to detect objects and distance or depth thereto as described herein. However, the camera(s) 146 may additionally or alternatively mount to the boom 118, stick 120, and/or other portions of the machine 102.

Depending on the arrangement and orientation of the camera(s) 146, the camera(s) 146 may have a field-of-view (FOV) in front of, to the sides of, to the back of, below, and/or above the machine 102. For example, continuing with the example above, the first camera may have a FOV to the right-side, in front, and/or to the back of the machine 102, the second camera may have a FOV to the right-side, the back, and/or to the left side of the machine 102, and third camera may have a FOV to the left-side, in front, and/or to the back of the machine 102. In some examples, the camera(s) 146 may have 3D FOV for viewing objects 106 in horizontal and vertical planes. The FOV 148 and 174 respectively of the cameras 170 and 172 may overlap such that image data may correspond to at least a shared portion of the environment and instance segmentation is performed on the image data to generate segmentation masks for hierarchical instances that may be compared against each other for correspondence and to therefore determine the depth or distance to the portions or segments of the objects.

In the example shown in FIG. 1, the machine 102 is shown including a camera 146 mounted to a right-side of the machine 102 and facing sideways. The camera 146 may have a FOV 148 that extends from the back of the machine 102 to the front of the machine 102. The FOV 148 of the camera 146, as noted above, may be substantially 180 degrees to image portions of the environment 100, as well as the working area 108, behind the machine 102, to the right of the machine 102, and in front of the machine 102. Additionally, the FOV 148 may image portions of the environment 100 above and below a horizontal plane, so as to have a vertical FOV. However, it is contemplated that the camera 146 may be mounted to other portions of the machine 102 and/or facing different directions relative to the machine 102. In some examples, at least a portion of the boom 118, the stick 120, and the work implement 122 may remain at least partly within the FOV 148 throughout the range of motion of the boom 118, the stick 120, and the work implement 122. In some examples, at least a portion of the FOVs of the camera(s) 146, respectively, may overlap.

The camera(s) 146 (which may include cameras 170 and 172) may generate image data 150 indicative of the environment 100. The camera(s) 146 may be any known type of analogue or digital image sensor, digital camera, and/or digital video camera. For example, the camera(s) 146 may be a high dynamic range (HDR) camera, a light-sensitive camera, and/or an ultra-sonic camera. However, other suitable types of imager(s) and/or sensor(s) are contemplated. In some examples, the camera(s) 146 may provide image data, image sequences, gray image data (e.g., grayscale), and/or color image data. In some examples, the machine 102 may further include any known type of sensor, such as one or more light detection and ranging (LIDAR) sensors, one or more sound navigation ranging (SONAR) sensors, one or more radio detection and ranging (RADAR) sensors, or any other suitable sensor type.

The collision avoidance system 104 may include an object detection controller 152 configured to determine, based at least in part on the image data 150, the presence of object(s) 106. For example, the object detection controller 152 may be in communication with the camera(s) 146 via a wired and/or a wireless communication link. In some examples, the object detection controller 152 may be configured to identify the object(s) 106 associated with the image data 150, for example, using image analysis techniques such as instance segmentation and/or hierarchical instance segmentation as described herein. The object detection controller 152 may be configured to determine a position, location, and/or bearing of the object(s) 106 and/or portions of the object(s) relative to a position of the camera(s) 146 and/or the machine 102. In some examples, the object detection controller 152 may be configured to identify specific objects and/or recognize the presence of specific objects. For example, the object detection controller 152 may utilize one or more algorithms for identifying people. Non-limiting examples of algorithms that may be used for identifying people or objects from the image data include convolutional neural networks and/or feature extraction algorithms that will be known to those with skill in the art. In response to receiving the image data 150, the object detection controller 152 may determine the presence, or absence, of person(s) within the image data 150. However, the image data 150 may be used to identify, or the object detection controller 152 may be trained to identify, other objects (e.g., animals, cars, etc.).

Hierarchical instance segmentation is implemented by the object detection controller 152 according to the systems and methods described herein. Image segmentation provides segmentation masks and detections of the assets such as people, vehicles, infrastructure. The image segmentation allows accurate and robust stereo matching of the objects from the image data of the cameras 170 and 172. Hierarchical instance segmentation allows for robust detection of the objects because hierarchy imposes a constraint to enforce more accurate and higher confidence matching as part of the object detection pipeline. The hierarchical instance segmentation allows for determination of depth of large objects by decomposing the object into structured parts of segments and features that can be determined individually at varying depths. Hierarchical instance segmentation also allows for accurate fusion with 3D sensors such as radar or lidar based point clouds. Accordingly, the object detection and collision avoidance systems of a machine 102 may be improved based on improved detection of systems without addition of complex or expensive sensors and systems.

In some examples, robustness checks on segmentation masks generated by the object detection controller may be implemented to ensure accurate matches of masks are selected for depth estimation of the objects and/or portions of the objects. Robustness checks on segmentation masks allow for continuous learning of a machine learning model implemented by the object detection controller 152 to perform segmentation on the image data from the cameras by selecting the best data for training for continuous improvement. The object detection controller 152 may use the cameras 170 and 172 for stereo camera detection of depth and/or distance. Multiple camera FOV and varying resolutions can be used to enable long-range detection, and 360-degree situational awareness for the machine 102. Computational assets of the machine 102 may be dedicated to accurately matching and ranging the masks of the instances of particular subsets of assets, for example based on appearance-based matching and/or object detection. Accordingly, different assets for computation may be assigned based on detection from the image data of a person or other such object.

Additionally, appearance-based stereo matching may be used for the image data from the cameras 170 and 172 to provide for additional confidence of the instance matching and can be combined with depth data for appearance-based re-identification, tracking, and tracking across cameras of objects within the environment 100. In some examples, low confidence matches between the image data from the two cameras may be identified or determined for additional robustness checks and/or additional confirmation using appearance-based matching or other such approaches. Since stereo vision may be used for depth calculation, depth accuracy may be higher and more reliable without requiring large amounts of 3D ground truth data. Wide non-rigid baseline stereo vision between the cameras 170 and 172 may be used only where needed (e.g., stereo in front of the machine 102, and possibly in rear of the machine 102, but perhaps not on a side of the machine 102). In some examples, such as described with respect to FIG. 3, the machine 102 may include six cameras (two in front, two in back, one on each side of the machine 102). Appearance-based and 3D position motion information for cameras may enable cross camera tracking to enable tracking, person identification, and/or other applications. The systems and methods described herein provide for improved performance of object detection systems and depth detection systems as compared with vision only or appearance only trackers and systems.

The alert system 112 may output alert(s) 114 for preventing collision(s) between the work implement 122 (and/or other portions of the machine 102) with the object(s) 106. For example, if the object(s) 106 are within the working area 108, the alert system 112 may generate an alert 114 for alerting the operator. After the collision avoidance system 104 determines the position 138 of the object(s) 106, the collision avoidance system 104 may compare the position 138 against the boundaries of the working area 108. For example, because the working area 108 and the position 138 of the object(s) 106 are represented in coordinate space, the collision avoidance system 104 may compare the coordinate positions to determine whether the alert system 112 should trigger an alert. If the coordinate position of the object(s) 106 is/are within the coordinate space of the working area 108, the alert system 112 may trigger an alert(s) 114. Here, the alert system 112 may receive signals, or other data, from the position controller 136 for activating the alert(s) 114. For example, upon determining that the object 106 is in the working area 108, or within a path of the work implement 122, the alert system 112 may be instructed or triggered to output the alert(s) 114.

The alert system 112 may be configured to activate device(s) upon receipt of one or more object signals indicative of the object(s) 106 in the working area 108. In some examples, the alert(s) 114 may be audible (e.g., series of beeps), visual (e.g., lights), haptic (e.g., vibrational), etc. The alert(s) 114 may be visually output on a display of the machine 102, which may include a user interface (UI) in which the operator may interface with for controlling one or more operation(s) of the machine 102. The device(s) configured to alert the operator may be mounted in the cab and/or at location(s) from which the operator is able to see and/or hear. Additionally, the collision avoidance system 104 may suppress alerts 114 associated with objects 106 that are within the FOV 148 of the camera 146, but outside of the working area 108. In such examples, the collision avoidance system 104 may detect the object 106 but avoids instructing the alert system 112 to issue the alert(s) 114 given the position of the object 106 outside of the working area 108.

In some examples, based on detecting the object(s) 106 within the working area 108, movement of the machine 102 and/or the work implement 122 may be restricted or otherwise controlled. For example, after detecting the object(s) 106, if the work implement 122 comes within a certain threshold distance of the object(s) 106, the operator may be prohibited from advancing the work implement 122 closer to the object(s) 106. For example, the collision avoidance system 104 may use the position 138 of the object(s) 106 to allow the operator to move the work implement 122 within a certain threshold distance of the object(s) 106. In some examples, the collision avoidance system 104 may continuously determine locations of the object(s) 106 via the image data 150 and locations of the work implement 122 via the sensor data 134. If the location of the work implement 122 advances towards the object(s) 106 and comes within the certain threshold distance, the collision avoidance system 104 may halt movement of the work implement 122 and/or cause the alert system 112 to output an alert 114. However, the operator, in some examples, may advance the work implement 122 away from the object(s) 106.

The collision avoidance system 104 may include a movement controller 154 configured to restrain, brake, or prevent movement of the work implement 122 in a direction towards the object(s) 106. For example, the movement controller 154 may control activation of one or more braking devices coupled to the machine 102 to slow a travel speed of the work implement 122, stop the work implement 122, and/or hold the work implement 122 at a fixed location within the working area 108. Such control may also prevent movement of the machine 102, the boom 118, and/or the stick 120.

The movement controller 154 may receive signals, or other data, from the position controller 136 for determining whether to halt or control movement of the machine 102. For example, upon determining that the object(s) 106 is/are in the working area 108, or within a path of the work implement 122, the movement controller 154 may be configured to prevent movement of the work implement 122 in a direction towards the object(s) 106.

With continued reference to FIG. 1, the environment 100 is shown including a first object 106(1) and a second object 106(2). The first object 106(1) and the second object 106(2) may be any type of object with which it would be desirable for the machine 102 to avoid a collision, such as a person. As discussed above, the first object 106(1) and the second object 106(2) may be identified via the image data 150 captured by the camera 146. In the example shown in FIG. 1, the first object 106(1) is located within the working area 108 while the second object 106(2) is located outside the working area 108.

As shown, the FOV 148 of the camera 146 may extend beyond the working area 108 in one or more coordinate directions and the FOV 174 may likewise extend beyond the working area 108. When the first object 106(1) is within the working area 108, alert(s) 114 may be output indicating the presence of the first object 106(1). Moreover, the movement controller 154 may prevent the operator advancing the work implement 122 in a direction 166 toward and/or to within a certain threshold distance or proximity 168 of the first object 106(1). Comparatively, for the second object 106(2), no alert 114 may be issued given that the second object 106(2) is located outside of the working area 108. In other words, because the second object 106(2) is located beyond the first boundary 128, and therefore outside the working area 108, the work implement 122 would not contact the second object 106(2). As such, even though the second object 106(2) may be detected by the object detection controller 152, because the second object 106(2) is outside of the working area 108, no alert 114 may be issued. This filtering of alerts 114 may serve to limit the amount of alert(s) 114 generated by the alert system 112. For example, the alert system 112 may generate alerts 114 corresponding to objects 106 detected by the object detection controller 152 and identified as being disposed within the working area 108, but may suppress (or in some instances, not generate) alerts 114 corresponding to objects 106 detected by the object detection controller 152 and identified as being disposed outside of the working area 108.

Moreover, as noted above, the collision avoidance system 104 may be trained to identify specific object(s) 106, such as people. In the example of FIG. 1, for example, the transport vehicle 126 is shown being within the working area 108 but the machine 102 may still be permitted to unload the debris 124 into the transport vehicle 126. Being as the collision avoidance system 104 may be trained to identify people, even though the transport vehicle 126 may be an object within the working area 108, the detection of the transport vehicle 126 may not halt or restrain movement of the machine 102, and/or alerts 114 may not be output. In this sense, the collision avoidance system 104 may filter or refine those object(s) that trigger the alert(s) 114 and/or restrain movement.

In some examples, one or more preventative alert(s) may be output by the alert system 112 if the object(s) 106 are in close proximity to the working area 108. The alert(s) 114 may not be output, and/or control of the machine 102 and/or the work implement 122 may not be prevented, but instead, the operator may receive an indication associated with the proximity of such object(s) 106. For example, if the second object 106(2) of FIG. 1 is within a certain threshold distance of the first boundary 128 (e.g., one foot), a prewarning may be output by the alert system 112.

In some examples, the camera(s) 146 may be oriented to only one side of the machine 102. As the machine 102 is rotates, object(s) 106 may come within a FOV 148 and/or 174 of the camera(s) 146. Therein, alert(s) 114 may be generated if the object(s) 106 come within the working area 108.

In some examples, a control system 156 may be in communication with the machine 102 via a network 158. The control system 156 may be located in the environment 100 and/or may be located remotely from the environment 100. In any of the examples described herein, the functionality of the collision avoidance system 104, the working area system 110, and the alert system 112 may be distributed so that certain operations are performed by the machine 102 and other operations are performed remotely. For example, the operations for establishing the working area 108 may be performed by the control system 156. In such instances, the machine 102 (or another intermediary device) may be configured to transmit the sensor data 134, for example, to the control system 156 for establishing the working area 108. However, the control system 156 may additionally, or alternatively, perform other operations of the collision avoidance system 104, the working area system 110, and the alert system 112.

The components of the control system 156 may be in communication with and/or otherwise operably connected to any of the components of the machine 102 via the network 158. The network 158 may be a local area network (“LAN”), a larger network such as a wide area network (“WAN”), or a collection of networks, such as the Internet. Protocols for network communication (e.g., wireless machine-to-machine communication protocols), such as TCP/IP, may be used to implement the network 158.

The cameras 170 and 172 may be used by the collision avoidance system 104 to survey a wide field of view and determine range and depth estimation with multiple cameras for the object detection controller 152. Due to high image distortion in wide field of view cameras, conventional methods such as bounding boxes or monocular vision are not suitable for accurate data and range and depth determinations. The system shown and described above provides a low-cost, yet robust stereo depth estimation scheme to achieve accurate range estimation of objects from cameras on a working machine 102. The object detection controller 152 implements hierarchical instance segmentation to determine segmentation masks and detect assets such as people, vehicles, and infrastructure. The system allows accurate and robust stereo matching of the assets in the field of view of the cameras 170 and 172. The hierarchical instance segmentation allows for robust detection as hierarchy imposes a constraint to enforce high confidence matching of segmentation masks. The hierarchical instance segmentation also allows for determination of depth of large objects by decomposing the object into structured parts of segments and features that can be determined individually at varying depths. Instance segmentation further allows for accurate fusion with 3D sensors such as radar or lidar based point clouds.

Accordingly, the cameras 170 and 172 may include low-cost monocular vision cameras to provide stereo depth estimations. Systems described herein employ stereo cameras that allow for accuracy. Such systems can be used for collision avoidance, NLOS tele-operation, autonomous systems, etc. When using multiple cameras generally, input data is sent to a central ECM of the machine 102 with some sort of hardware accelerated edge AI, deep learning capability, such as a GPU, FPGA, DSP/MMA or other specialized hardware. The system described herein employs two or more monocular cameras with the image data subject to a hierarchical instance segmentation that provides instance segmentation masks and detections of the assets such as people, vehicles, and infrastructure. The hierarchical instance segmentation allows for determination of depth of large objects by decomposing the object into structured parts of segments and features that can be determined individually at varying depths. The image data from the cameras 170 and 172 is processed through a pipeline to apply instance segmentations, the resulting mask positions are then compared rather than a typical pixel-wise comparison, with the comparison of the mask positions used for depth perception.

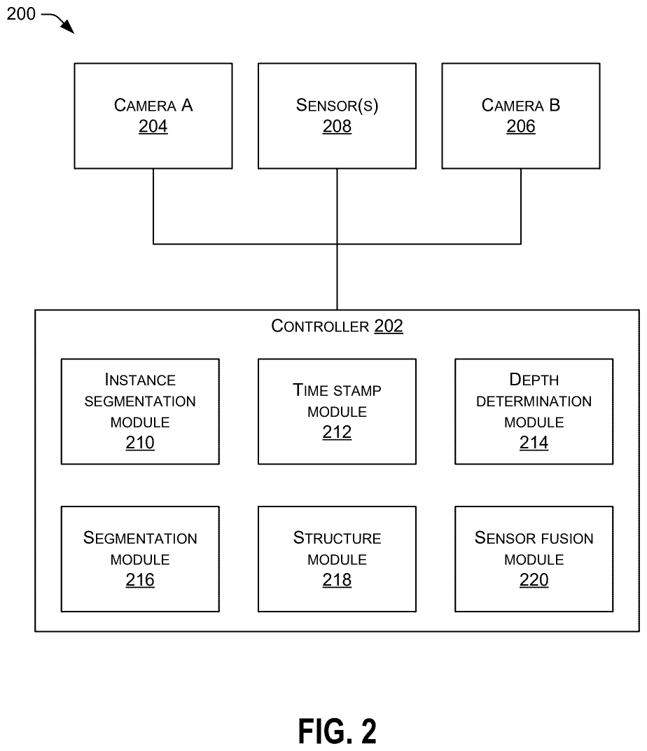

FIG. 2 illustrates a system architecture for a machine 200 with multiple cameras for determining depth and range of objects in an environment using hierarchical instance segmentation, according to at least one example. The machine 200 is depicted having camera A 204, camera B 206, and other sensor(s) 208 for detecting an environment surrounding the machine 200. Camera A 204 and camera B 206 may include monocular vision cameras and may include wide-angle cameras or other camera systems such as low-cost wide-field of view cameras to provide coverage of the surrounding environment using the fields of view of the cameras. The FOV of the cameras overlap to provide views of the same objects from the different perspectives of camera A 204 and camera B 206. The additional sensor(s) 208 may include radar array sensors, lidar sensors, and other sensors used for detecting conditions of the environment surrounding the machine 200.

The machine 200 includes a controller 202 which may be implemented in an electronic control module (ECM) of the machine 200. The controller 202 may include components of a computing device, such as the computing device of FIG. 6 described below. The controller 202 is communicably coupled with camera A 204 and camera B 206 through one or more wired and/or wireless communications. Though the machine 200 is depicted with respect to FIG. 2 as having two cameras, the machine 200 may have more than two cameras, such as two cameras directed forward from the cab of the machine 200, two cameras directed rearward from the cab of the machine 200, and one or more cameras directed to the left-side and/or right-side of the machine 200.

The controller 202 is depicted as having sub-components or modules that may be associated with particular architecture and/or processes performed by the controller 202 in response to instructions stored on non-transitory media. Though depicted with a particular breakdown and organization, the controller 202 and the sub-components may have different organizations and/or structures as will be understood by those with skill in the art. Accordingly, the particular structure shown therein is for illustrative purposes only and not intended to be limiting with respect to the structure or functionality of the components of the controller 202.

The controller 202 includes an instance segmentation module 210, a time stamp module 212, a depth determination module 214, a segmentation module 216, a structure module 218, and a sensor fusion module 220. The modules depicted therein provide capabilities for the controller to receive image data from camera A 204 and camera B 206 and perform depth and range estimation of objects and portions of objects in the environment around the machine 200. The controller modules may perform hierarchical instance segmentation. Hierarchical instance segmentation is implemented according to the systems and methods described herein, as opposed to conventional object detection-based bounding boxes. Image segmentation provides segmentation masks and detections of the assets such as people, vehicles, infrastructure. The image segmentation allows accurate and robust stereo matching of the objects from the image data of the cameras. Hierarchical instance segmentation allows for robust detection of the objects because hierarchy imposes a constraint to enforce more accurate and higher confidence matching as part of the object detection pipeline. The hierarchical instance segmentation allows for determination of depth of large objects by decomposing the object into structured parts of segments and features that can be determined individually at varying depths. Hierarchical instance segmentation also allows for accurate fusion with 3D sensors such as radar or lidar based point clouds. Accordingly, the object detection and collision avoidance systems of a machine may be improved based on improved detection of systems without addition of complex or expensive sensors and systems.

The instance segmentation module 210 identifies and delineates individual objects within an image using computer vision techniques. The instance segmentation module 210 assigns a label to each identified portion, providing context and a detailed understanding of distinct instances in the scene. Instance segmentation as performed by the instance segmentation module 210 provides for pixel-level boundaries of each object in the image data, generating an instance mask wherein pixels outside of the pixels associated with the instance are left untouched while pixels outside of the instance may be masked off. The instance segmentation module 210 uses one or more algorithms to generate a pixel-by-pixel segmentation mask of the shape of each instance in the image data. Segmentation masks may be created by assigning, through an algorithm, a label to each individual pixel in the image. The segmentation may be performed by algorithms that consider pixel color, intensity, texture, spatial location, similarity to nearby pixels, or other such approaches. Algorithms to perform such segmentation may include neural networks trained to predict a pixel-wise class, edge detection that may be used to detect edges in an image, or other algorithms that will be known to those with skill in the art. The instance segmentation module 210 may leverage artificial intelligence, machine learning, and other such approaches to perform the instance segmentation, as will be understood by those with skill in the art.

The instance segmentation module 210 may further perform hierarchical instance segmentation. Hierarchical instance segmentation is a technique that uses multiple levels of segmentation to group and refine three-dimensional objects. The hierarchical instance segmentation approach may enable determination of depth or range to large objects by decomposing the object into structured parts of segments and/or features that can be identified and the depth to each may be determined individually. The instance segmentation module 210 is used to determine segmentation masks versus object detection using bounding boxes as in conventional approaches. The instance segmentation module 210 provides segmentation masks and detections of objects such as people, vehicles, terrain, and/or infrastructure. The segmentation masks from image data of camera A 204 and camera B 206 may be compared and matched together to provide accurate and robust stereo matching that may be used to provide depth estimations to the objects. The instance segmentation module 210 additionally allows for sensor fusion with 3D sensors such as radar or lidar based point clouds, for example using the sensor fusion module 220 of FIG. 2. Such sensor fusion may not be possible with bounding box approaches as there may be confusion between foreground and background for the sensor fusion.

The time stamp module 212 provides for accurate and synchronized network time stamps to provide for image data to be compared at or near the same time, thereby ensuring that the image data and subsequent instance masks are compared at the same time (e.g., same position of the machine 200 during motion of the machine or of the objects). The time stamp module 212 may implement a precision time protocol such as defined by IEEE 1588 standard and/or IEEE 802.1AS for synchronization of time-sensitive applications such as video or image data from the cameras. By ensuring that the image data and/or video data is synchronized, the instance segmentation masks may be accurately compared at simultaneous times. The image data from the cameras may be time stamped and the time stamped data may be passed on for instance segmentation.

The depth determination module 214 receives the segmentation masks from the instance segmentation module 210 and used the masks to determine a depth determination based on comparison and matching of the instance segmentation masks. The disparity information from the pair of segmentation masks (e.g., first mask from camera A 204 and second mask from camera B 206 both captured at the same time) can be used to calculate the object (or instance) distance from the camera (or machine) by matching corresponding pixels between the image masks. The depth determination module 214 may determine depths to different objects and/or portions of objects within the environment. By enabling hierarchical instance segmentation, the system of the machine 200 may provide more accurate depth information to an object avoidance and collision avoidance system.

The segmentation module 216 may be used by the machine 200 to perform robustness checks on the segmentation masks and to additionally provide for continuous training and improvement of algorithms and/or models used in instance segmentation and depth estimation. The segmentation module allows for continuous learning by selecting data for training for continuous improvement of the object detection system. The segmentation module 216 may also be used for semantic understanding of the objects in the FOV of the cameras as the images can be analyzed by one or more computer vision algorithms, for example to identify particular equipment or objects such as personnel or other such objects. Such computer vision algorithms may include algorithms having various structures that enable identifying and locating objects within the image data and may include examples such as convolutional neural networks, YOLO (You Only Look Once), scale-invariant feature transform, speeded-up robust features, and other structures and algorithms that will be apparent to those with skill in the art. The segmentation module 216 may also be used for cross-camera tracking, person re-identification based on appearance and/or geometric tracking or other such techniques that provide improved performance over vision and/or appearance-only tracking systems for the environment.

The structure module 218 may be used in connection with the segmentation module 216 to decompose the object into different sub-components for higher-accuracy depth determination than when comparing a distance of an entire large object as viewed from stereo cameras. The structure module may identify different sub-components for the hierarchical instance segmentation of objects in the image data such that the instance segmentation module and/or segmentation module may generate segmentation masks for comparison and determination of the depth estimation.

The sensor fusion module 220 may be used to combine sensor data from one or more 3D sensor systems, such as lidar and/or radar point cloud data with depth estimation data from the depth determination module 214 to provide increased accuracy and/or confidence in the depth determination from the depth determination module 214.

FIG. 3 illustrates a system 300 for implementation on a machine including six example cameras communicably coupled with an ECM 302 of the machine, according to at least one example. The cameras 304A-304F (collectively cameras 304) are disposed on-board the machine, such as the machine 102 of FIG. 1. The systems and methods described herein do not require a narrow, rigid baseline for stereo matching as typical stereo camera systems require, and therefore the cameras 304 may be spread out across the machine. As compared with a typical stereo camera setup that requires a rigid baseline that is unchanging and preferably narrow to enable accurate stereo vision estimations, the image processing techniques described herein enable image data from various locations and distances apart that may also not necessarily remain fixed or rigid (e.g., so long as the relative locations of the cameras are known from machine telemetry or modeling of articulating components of a machine). Such a system 300 therefore also enables a wide baseline that may be more suitable for depth determination across greater distances, as will be appreciated by those with skill in the art. The system 300 is depicted with six cameras 304 for example to provide stereo camera coverage at the front and rear of the machine, but may not provide stereo vision at the sides of the machine. In other embodiments, the system 300 may include greater or fewer than six cameras 304.

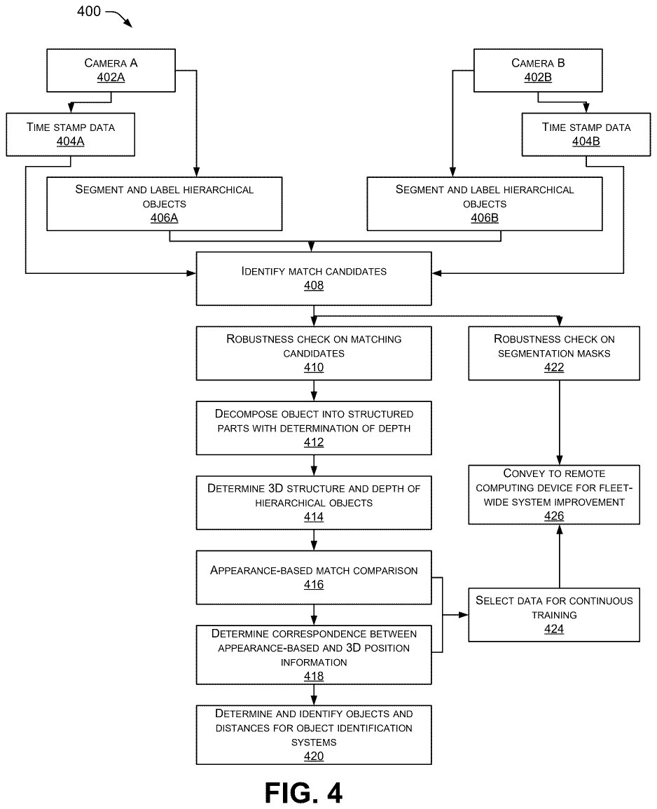

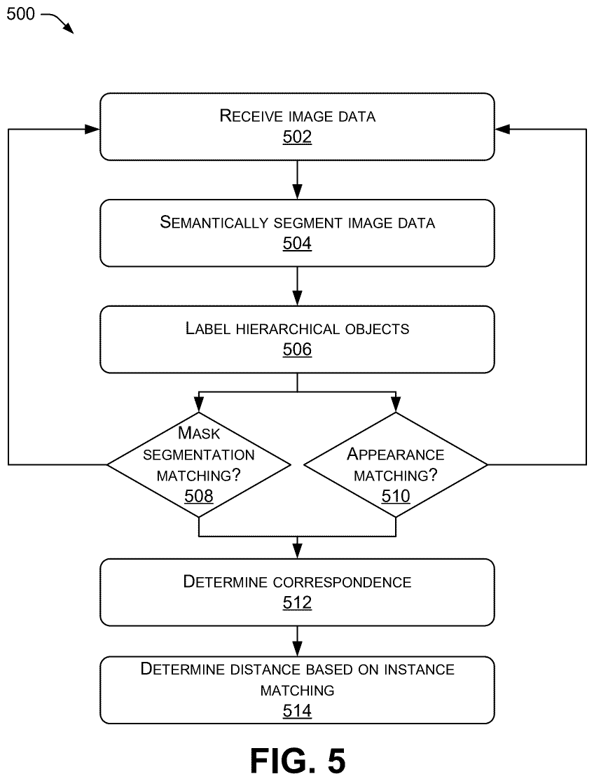

FIGS. 4-5 illustrate flow diagrams of example methods as described herein, according to examples of the present disclosure. The processes 400 and 500 may be performed, at least in part, by a processor of a computing device, such as the user device and/or a subsystem of the work machine as described herein. The processes 400 and 500 may be performed on one or more devices within the user device. The processes 400 and 500 may be implemented as processor-executable instructions that may be stored on a suitable non-transitory storage medium. Though depicted in a particular order in FIGS. 4-5, the steps of processes 400 and 500 may be performed in other orders or arrangements, and in some examples, processes 400 and 500 may include additional or fewer steps than depicted in FIGS. 4-5.

FIG. 4 illustrates a method 400 for performing hierarchical instance segmentation to determine depth and range of objects from a machine, according to at least one example. The illustration in FIG. 4 begins from camera A 402A and camera B 402B to begin the method 400. The steps of the method 400 may be carried out using the ECM 302 and/or another computing device of the machine. The method 400 includes image data flowing from camera A 402A and camera B 402B with associated time stamp data 404A and 404B to the ECM. The ECM receives the image data with the time stamps and performs one or more operations, such as the operations described at steps 406A-406B through step 426.

At step 406A the ECM receives the image data with the time stamp data and performed segmentation to label hierarchical objects using a hierarchical instance segmentation approach as described herein for the image data from camera A 402A. At step 406B the ECM receives the image data with the time stamp data and performs segmentation to label hierarchical objects using hierarchical instance segmentation as described herein. The time stamp data may be used by the ECM to identify images from video data and/or to identify image data from a single point in time such that the machine is at a single position in space and time when the image data from camera A 402A and the image data from camera B 402B is compared.

At step 408, the ECM performs matching of instance segmentation masks from the hierarchical instance segmentation. The candidates for matching may be identified based on the labels and/or based on the shape and/or content of the pixels contained within the segmentation masks. The matching candidates may then be evaluated with a robustness check at step 410. The robustness checks on the segmentation masks and the matching thereof may be implemented to ensure accurate matches of masks are selected for depth estimation of the objects and/or portions of the objects. Robustness checks on segmentation masks allow for continuous learning of a machine learning model implemented by the ECM to perform segmentation on the image data from the cameras by selecting the best data for training for continuous improvement.

At step 410 two segmentation masks, one from the image data from each camera, are received at the computing device. Using hierarchical instance segmentation there are corresponding segmentation masks for the component parts of the objects. With the two cameras seeing the same scene, or at least a portion of the same scene at or about the same point in time but from different viewpoints based on the locations of the cameras. Despite the different viewpoints the image segmentation masks will be similar, so one or both of the images can be rectified (e.g., rectify image data from just one camera to algin with the other, or rectify both sets of image data so that they align to a single new coordinate system). The two segmentation masks (including the hierarchical sub-components) may then be overlaid and a score may be computed, such as an Intersection Over Union (IoU, also known as Jaccard Index). If the segmentation masks overlay then the score will be higher, (e.g., close to one) and if the segmentation masks don't overlay well then, the score may be low (e.g., close to zero). Additionally, each instance segmentation network will provide a confidence score, which can be weighted and combined with the IoU/Jaccard score.

At step 412, the ECM decomposes the objects into structured parts for determination of depth. The decomposition may be performed using a machine learning approach and/or algorithm such as described herein to identify distinct portions of the objects and to identify portions that are spatially constrained within a limited space such that the depth determinations may be used accurately for collision avoidance and other systems. The ECM uses the decomposed object to determine a three-dimensional structure and depth to the different hierarchical objects at step 414. The ECM may therefore determine a three-dimensional representation of the object and/or environment using the image data and the instance segmentation as described herein.

The ECM may perform an appearance-based comparison between objects in the first image data and the second image data at step 416. The appearance-based stereo matching may be used to ensure that only highest confidence matches of segmentation masks and also further may be combined with depth data for appearance-based re-identification, tracking, and tracking across cameras around the machine. The ECM may further determine correspondence between the appearance-based comparison and three-dimensional position information at step 418. Such correspondence may be used for cross camera tracking and re-identification of objects that are re-encountered within the environment. The correspondence between the appearance-based and three-dimensional position information is based on alignment of the three-dimensional information with the segmentation masks. Because this is a vision-based system the alignment of the 3D information with the segmentation masks is available because the instance segmentation masks and the stereo depth is calculated from the same overlapping images so depth and segmentation masks are automatically aligned. Accordingly, dense stereo matching may be used to get 3D points that align with the segmentation masks.

The instance segmentation masks help to eliminate confusing background 3D points that would occur with a bounding box matching approach. Additionally, the method and/or system may use sparse stereo matching by calculating the depth of features like edges or corners aligned with segmentation masks. In some examples, once the hierarchical segmentation masks are determined then the disparity/depth of the masks may be calculated to determine the range to the object and/or portion of the object. Having sub-components of the hierarchical objects may give better depth estimation for objects especially for large objects. With the 3D size/location and the segmentation and semantic classification, the system may perform checks on the size of the person/object and the location of the person/object in relation to the ground, etc. to help reject false alarms and increase confidence in the mask detections and range estimates.

At step 420 the ECM may then determine and identify objects and associated distances for object identification systems such as collision avoidance systems, drivable ground surface, operator information systems, and other such systems of the machine.

The method 400 further provides for additional robustness checks on segmentation masks at step 422 to provide for fleet-wide improvement of collision avoidance systems and object detection systems at step 426. The additional robustness checks allow for continuous learning by selecting data for training based on a level of confidence exceeding a predetermined threshold level of confidence. Further, the hierarchical class and appearance information may be selected at step 424 to further provide for continuous learning of the systems for object detection and subsequent systems that consume outputs of an object detection system at step 426.

FIG. 5 illustrates a method 500 for performing hierarchical instance segmentation to determine depth and range of objects from a machine, according to at least one example. The method 500 may be performed by an ECM of a machine in a work environment. The method 500 begins with the ECM receiving image data at step 502 from two or more cameras of the machine, with at least a partially overlapping field of view such that an object may be visible to both cameras and therefore be present in image data from both of the cameras.

The method 500 further includes semantically segmenting the image data at step 504. The semantic segmentation of the image data allows for appearance-based and/or cross-camera tracking of objects and may also identify objects that may have higher priority assigned to them, such as personnel. The semantically segmented image data is then labeled into hierarchical objects at step 506 through an algorithm such as one or more of the algorithms described herein or other such algorithms as will be known to those with skill in the art that may be embodied in the ECM to decompose objects into sub-components such that each sub-component may have an associated depth determination such that the different portions of the object that may be nearer or farther from the machine and therefore collision avoidance systems may be implemented with a high degree of confidence and accuracy.

At steps 508 and 510 the hierarchical objects that have been segmented using hierarchical instance segmentation are compared for matching of segmentation masks as well as appearance matching. In the event that either the mask segmentation or the appearance matching fails to reach a threshold level of confidence, the method returns to step 502. In the event that the segmentation masks match and the appearance matches then the method 500 proceeds to step 512.

At step 512, the ECM determines a correspondence between the hierarchical instances from the first camera data and the second camera data. The correspondence and a subsequent disparity may be used to determine a distance based on instance matching at step 514. The distance to the instances, determined based on stereo matching of the instances may then be used by object detection, object tracking, collision avoidance, and other such systems of a machine. FIG. 6 is a block diagram illustrating physical components of an example computing device with which examples of the present disclosure may be practiced. The computing system 600 may include at least one processing unit 602 and the system memory 604. The system memory 604 may comprise, but is not limited to, volatile (e.g., random access memory (RAM)), non-volatile (e.g., read only memory (ROM)), flash memory, or any combination thereof. System memory 604 may include an operating system 606, one or more program instructions 608, and may include sufficient computer-executable instructions for operating the object detection techniques described herein. Operating system 606, for example, may be suitable for controlling the operation of the computing system 600. Furthermore, examples may be practiced in conjunction with other operating systems, or other application programs and is not limited to any application or system. The computing system 600 may also include one or more input device(s) 612 (e.g., keyboard, mouse, pen, touch input device, etc.) and one or more output device(s) 614 (e.g., display, speakers, printers, etc.).

The computing system 600 may also include additional data storage devices (removable or non-removable) such as, for example, magnetic discs, optical discs, or tape. Such additional storage is illustrated by removable storage 616 and a nonremovable storage 618. The computing system 600 may also contain a communication connection 620 that may allow the computing system 600 to communicate with other computing devices 622 such as over a network in a distributed computing environment, for example, an intranet or the Internet. The communication connection 620 is an example of a communication medium, via which computer-readable transmission media (i.e., signals) may be propagated.

Program modules may include routines, programs, components, data structures, and other structures that may perform tasks or that may implement abstract data types. Moreover, examples may be practiced with other computer system configurations, including hand-held devices, multiprocessor systems, microprocessor-based or programmable user electronics, minicomputers, mainframe computers, and the like. Examples may also be practiced in distributed computing environments where tasks are performed by remote computing and processing devices that are linked through a communications network. In a distributed computing environment, programming modules may be in both local and remote memory storage devices. Furthermore, examples may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SOC)). Examples may also be practiced using other technologies capable of performing logical operations such as, for example, AND, OR, and NOT, including but not limited to mechanical, optical, fluidic, and quantum technologies. In addition, examples may be practiced within a general-purpose computer or in other circuits or systems.

Examples may be implemented as a computer process (method), a computing system, or as an article of manufacture, such as a computer program product or computer-readable storage medium. The computer program product may be a computer storage medium readable by a computer system and encoding a computer program with instructions for executing a computer process. Accordingly, hardware or software (including firmware, resident software, micro-code, etc.) may provide examples discussed herein. Examples may take the form of a computer program product on a computer-usable or computer-readable storage medium having computer-usable or computer-readable program code embodied in the medium for use by, or in connection with, an instruction execution system.

Examples of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented within the computing system 600 or any other computing devices 622, in combination with the computing system 600, where functionality may be brought together over a network in a distributed computing environment, for example, an intranet or the Internet to perform the functions described herein. Systems, devices, and processors described herein are provided as examples; however, other systems, devices, and processors may comprise the memory storage and processing unit, consistent with the described disclosure.

### INDUSTRIAL APPLICABILITY

Systems and methods provide for object detection using image data from low-cost cameras that may be connected to a machine operating in an environment. The example systems and methods of the present disclosure are applicable to a variety of machines, such as, for example, an automobile, marine vehicles, a truck, an agricultural vehicle, a paving machine, a mining machine, and/or construction vehicles. Such machines may include a collision avoidance system, a working area system, and/or an alert system configured to assist a machine operator (e.g., aboard the machine or remote from the machine), or an autonomous machine, with avoiding collisions with other machines, personnel, and/or objects. The collision avoidance system may include or be communicatively coupled to an alert system configured to alert a machine operator when objects come within a working area of a machine. A working area system may define a working area representing an area within which an operator intends to operate a machine in order to perform one or more tasks (e.g., loading and unloading debris). In some examples, an operator may position a work implement at various locations within an environment for recording position coordinates corresponding to a working area. After an operator has established boundaries of a working area, a working area controller may correlate position coordinates with a working area in coordinate space. An operator may be restricted from operating the machine, or a work implement connected to the machine, outside of the boundaries of the working area.

The systems and methods of the present disclosure provide for object detection of objects in the environment using image data from two or more cameras on the machine. The systems and methods described herein provide for detecting objects in an environment, such as a worksite, using sensors such as monocular vision cameras. In some examples, a machine may define a working area within the environment. In some examples of the systems and methods, one of the sensors may detect an object in the environment and may determine whether the object is within the working area. Objects that are within the working area may cause alerts to be issued and/or movement of the machine, or a work implement connected to the machine, to be controlled. Some examples of the systems and methods described herein are related to the use of cameras, along with other sensors, to perform hierarchical image segmentation and depth detection. That is, the object(s) may be detected and the distance to the segments or portions of the objects may be readily identified based on image data from synchronized cameras. Accordingly, the systems and methods herein may provide for object detection and depth estimation for objects and portions of objects within the working area.

The present description provides for a low-cost and robust stereo depth estimation to achieve accurate range estimation using multiple wide-angle cameras. The image data from the cameras of the machine are processed using a hierarchical instance segmentation technique that is used to provide depth estimation of the distances to the objects in the environment. Hierarchical instance segmentation is implemented according to the systems and methods described herein, as opposed to conventional object detection-based bounding boxes. Image segmentation provides segmentation masks and detections of the assets such as people, vehicles, infrastructure. The image segmentation allows accurate and robust stereo matching of the objects from the image data of the cameras. Hierarchical instance segmentation allows for robust detection of the objects because hierarchy imposes a constraint to enforce more accurate and higher confidence matching as part of the object detection pipeline. The hierarchical instance segmentation allows for determination of depth of large objects by decomposing the object into structured parts of segments and features that can be determined individually at varying depths. Hierarchical instance segmentation also allows for accurate fusion with 3D sensors such as radar or lidar based point clouds. Accordingly, the object detection and collision avoidance systems of a machine may be improved based on improved detection of systems without addition of complex or expensive sensors and systems.

The depth estimation system described herein provides for distance monitoring at or near real-time and therefore may be used to monitor objects at or near real-time in the environment for object detection and/or collision avoidance. Such determinations may occur at a rate of approximately ten to thirty frames per second, for example processing a frame in less than 33 milliseconds. Accordingly, the system may be designed to provide less than 250 milliseconds of latency/processing time.

The example collision avoidance system of the present disclosure may identify objects within and outside a working area to reduce or eliminate nuisances to an operator. By defining the working area, alert(s) may be selectively output for alerting the operator. For example, if an object is detected outside of the working area the collision avoidance system may refrain from outputting an alert because machine may not contact the object. Alternatively, if an object is detected inside the working area, the collision avoidance system m cause an alert to be output. In some examples, a movement controller may restrain operation of the work implement based on the collision avoidance system detecting object(s) within the working area. For example, the movement controller may slow a travel speed of the work implement, stop the work implement, and/or hold the work implement at a fixed location. With the collision avoidance system, the risk of contact or collisions between the machine and surrounding objects are minimized. Additionally, the collision avoidance system may reduce alerts output to the operator to reduce operator fatigue as well as instill operator trust in the collision avoidance system detecting objects.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A method, comprising:
receiving first image data from a first camera affixed to a work machine;
receiving second image data from a second camera affixed to the work machine;
determining a first segmentation mask for an object represented in the first image data, the first segmentation mask comprising a first hierarchical instance segmentation of the object;
determining a second segmentation mask for the object represented in the second image data, the second segmentation mask comprising a second hierarchical instance segmentation of the object;
determining a correspondence between the first segmentation mask and the second segmentation mask;
determining a distance from the work machine to the object based on the correspondence; and
controlling movement of a machine component of the work machine based at least in part on the distance.

2. The method of claim 1, wherein determining the first segmentation mask comprises:
determining one or more sub-components of the object using a computer vision technique;
decomposing the object into a plurality of structured parts; and
determining a segmentation mask for a part of the plurality of structured parts.

3. The method of claim 1, wherein determining the correspondence between the first segmentation mask and the second segmentation mask comprises:
rectifying the first image data or the second image data prior to determining the first segmentation mask and the second segmentation mask to algin to a single coordinate system; and
determining a Jaccard index for the first segmentation mask and the second segmentation mask.

4. The method of claim 1, further comprising:
determining an appearance-based comparison between the object represented in the first image data and the second image data; and
performing cross camera tracking of the object as a relative position of the object and the work machine changes over time.

5. The method of claim 4, further comprising determining a training dataset for continuous learning based at least in part on the correspondence and the appearance-based comparison.

6. The method of claim 1, wherein controlling movement of the work machine comprises providing the distance to a collision avoidance system of the work machine and resisting operation of the work machine in a manner that increases a probability of a collision between the work machine and the object.

7. The method of claim 1, wherein the first image data and the second image data comprise wide-angle monocular vision image data from the first camera and the second camera.

8. A system, comprising:
a work machine;
a first camera;
a second camera; and
an electronic control module configured to perform operations comprising:
receiving first image data from the first camera;
receiving second image data from the second camera;
determining a first segmentation mask for an object represented in the first image data, the first segmentation mask comprising a first hierarchical instance segmentation of the object;
determining a second segmentation mask for the object represented in the second image data, the second segmentation mask comprising a second hierarchical instance segmentation of the object;
determining a correspondence between the first segmentation mask and the second segmentation mask;
determining a distance from the work machine to the object based on the correspondence; and
controlling an operation of the work machine based at least in part on the distance.

9. The system of claim 8, further comprising a third camera and a fourth camera, wherein the first camera and the second camera share at least a portion of a first field of view at a front of the work machine and the third camera and the fourth camera share at least a portion of a second field of view at a rear of the work machine.

10. The system of claim 9, wherein the electronic control module is further configured to perform additional operations comprising:
determining a third segmentation mask for a second object represented in third image data from the third camera;
determining a fourth segmentation mask for the second object represented in fourth image data from the fourth camera;
determining a correspondence between the third segmentation mask and the fourth segmentation mask;
determining a second distance from the work machine to the second object based on the correspondence between the third and fourth segmentation masks; and
controlling the operation of the work machine based on the second distance.

11. The system of claim 9, further comprising a fifth camera directed towards a first lateral side of the work machine and a sixth camera directed towards a second lateral side of the work machine.

12. The system of claim 8, wherein the first image data and the second image data are time synchronized using time stamp data.

13. The system of claim 8, wherein determining the first segmentation mask and the second segmentation mask comprise:
determining one or more sub-components of the object using a computer vision technique;
decomposing the object into a plurality of structured parts; and
determining a segmentation mask for a part of the plurality of structured parts.

14. The system of claim 8, wherein controlling the operation of the work machine comprises providing the distance to a collision avoidance system of the work machine and resisting operation of the work machine in a manner that increases a probability of a collision between the work machine and the object.

15. A non-transitory computer-readable medium having instructions stored thereon that, when executed by a processor, causes the processor to perform operations:
receiving first image data from a first camera affixed to a work machine;
receiving second image data from a second camera affixed to the work machine;
determining a first segmentation mask for an object represented in the first image data, the first segmentation mask comprising a first hierarchical instance segmentation of the object;
determining a second segmentation mask for the object represented in the second image data, the second segmentation mask comprising a second hierarchical instance segmentation of the object;
determining a correspondence between the first segmentation mask and the second segmentation mask;
determining a distance from the work machine to the object based on the correspondence; and
controlling an operation of the work machine based at least in part on the distance.

16. The non-transitory computer-readable medium of claim 15, wherein the first image data and the second image data are time synchronized using time stamp data.

17. The non-transitory computer-readable medium of claim 15, wherein determining the first segmentation mask and the second segmentation mask comprise:
determining one or more sub-components of the object using a computer vision technique;
decomposing the object into a plurality of structured parts; and
determining a segmentation mask for a part of the plurality of structured parts.

18. The non-transitory computer-readable medium of claim 15, wherein the operations further comprise:
determining an appearance-based comparison between the object represented in the first image data and the second image data; and
performing cross camera tracking of the object as a relative position of the object and the work machine changes over time.

19. The non-transitory computer-readable medium of claim 18, further comprising determining a training dataset for continuous learning based at least in part on the correspondence and the appearance-based comparison.

20. The non-transitory computer-readable medium of claim 15, wherein controlling the operation of the work machine comprises providing the distance to a collision avoidance system of the work machine and resisting operation of the work machine in a manner that increases a probability of a collision between the work machine and the object.
